(19) United States
(12) Patent Application Publication
(10) Pub. No.: US 2012/0305106 A1
(43) Pub. Date: Dec. 6, 2012

(54) ACTUATOR MOUNTING BRACKET FOR DAMPER

(75) Inventors: Thomas Clifford Morse, Greenville, NC (US); Jeremiah Scott Foreman, Washington, NC (US)

(73) Assignee: Flanders Corporation

(21) Appl. No.: 13/151,885

(22) Filed: Jun. 2, 2011

(51) Int. Cl. F16K 51/00; B23P 19/00

(52) U.S. Cl. 137/343; 29/428

(57) ABSTRACT

A compact damper and an actuator mounting bracket are provided for controlling fluid flow through a duct. The actuator mounting bracket includes two mounting legs and a mounting plate extending between the mounting legs. The mounting legs are configured to be fixed to corresponding mounting extensions that extend from and are integral to the damper. The actuator mounting bracket defines various slots and holes to provide adjustability in both the position of the actuator mounting bracket with respect to the damper and the type of actuator that can be accommodated by the mounting bracket. In this way, an actuator may be installed/replaced while maintaining the pressure integrity of the damper. In addition, the integral mounting extensions facilitate proper alignment of the actuator with the damper and provide additional support for larger actuators. Methods for attaching an actuator to a damper are also provided.

### BACKGROUND

Dampers are used in a variety of industrial and research applications to stop or regulate the flow of a fluid, typically air, inside a duct, chimney, Variable Air Volume (VAV) box, air handler, and other air handling equipment. For example, dampers are often used in containment systems designed to protect workers and the general public from potential exposure to toxic, hazardous, dangerous, potent, lethal and/or harmful organisms, bacteria, viruses, chemicals and other compounds in various fields of industry, such as in the medical, pharmaceutical, biopharma, and agricultural fields.

In some cases, containment systems are designed to hold HEPA filters or other filters for controlling particulate matter and HEPA or carbon absorbers for controlling gas-phase components. Industry standards often govern the design, materials of construction, performance and quality assurance of dampers, such as dampers used in containment systems. Examples of industry standards include ASME AG-1, ASME/ANSI N509, N510, and N511, among others.

In general, containment systems are comprised of multiple sections connected in series via gasketed and bolted or welded connections. Such systems may be installed on the supply side or exhaust side of ventilation systems depending on the specific application. Each section of the containment systems generally serves a specific function. Dampers installed in such systems are typically used to isolate the containment system from upstream or downstream ductwork.

Dampers for containment systems and other types of systems often require an actuator to be used to open and close the damper. When the damper is closed, the actuator must be able to effectively create a seal that is capable of meeting the leak-test requirements of any applicable industry standards, such as ASME N510 and ASME N511. Actuators may be manually, pneumatically, electrically or mechanically operated, may vary in size, shape, torque output, and type of shaft interface and may include a variety of different features and functions.

The large variety of available actuators creates a challenge in manufacturing dampers that are compatible with several different actuators, without having to modify the damper or damper accessories to accommodate the particular actuator to be used. In addition, in some cases an actuator has to be replaced after the damper is installed and placed in operation in the field. Replacing an actuator with a different brand in the field may require the replacement or modification of the damper, damper bracket, or other damper accessories to accommodate the new actuator. In some cases, such replacements compromise the pressure integrity of the damper, for example, by creating a leak path during field welding. Due to the critical nature of some applications, the damper would need to be leak-tested after installation of the damper to ensure the integrity of the pressure boundary. Furthermore, the alignment between the actuator and the damper shaft is important to the proper and efficient functioning of the damper. Each time an actuator is installed on a damper, the installation technicians expend considerable time and effort to ensure proper alignment, and the potential always exists that the actuator may not be installed in proper alignment with the damper.

Applicant has discovered then that it would be desirable to provide a bracket for mounting an actuator to a damper that is easily installed on the damper, allows for accurate alignment of the actuator with the damper with minimal technician effort, and can accommodate various types and sizes of actuators and/or can be replaced in the field while maintaining the pressure integrity of the damper. As described in greater detail below, a variety of challenges were identified and overcome through Applicant's efforts to invent and develop such a mounting bracket.

### BRIEF SUMMARY

Accordingly, various embodiments of a damper are provided for controlling fluid flow through a duct between an upstream portion of the duct and a downstream portion of the duct. The damper may include a damper housing defining an upstream end and a downstream end, a first flange and a second flange, a damping member, a damper shaft, and an actuator mounting bracket. The first flange may be fixed to the upstream end of the damper housing, and the second flange may be fixed to the downstream end of the damper housing. Each flange may be configured to be attached to the respective upstream and downstream portions of the duct. The damping member may be disposed within the housing and may be configured to be movable between a closed position, in which the damping member is substantially perpendicular to the direction of fluid flow through the housing, and an open position, in which the damping member is substantially parallel to the direction of fluid flow through the housing. The damper shaft may be connected to the damping member and may extend through the damper housing. The damper shaft may be configured to move the damping member between the open and closed positions. In addition, the actuator mounting bracket may be configured to attach an actuator to the damper housing, wherein the actuator is configured to engage and rotate the damper shaft for moving the damping member between the open and closed positions.

In this regard, the first flange may define a first mounting extension, and the second flange may define a second mounting extension. The actuator mounting bracket may define first and second mounting legs and a mounting plate extending between the first and second mounting legs. The first and second mounting legs may be configured to be fastened to the first and second mounting extensions, respectively, and the mounting plate may be configured to be fastened to the actuator.

In some embodiments, the mounting plate of the actuator mounting bracket may define a multiple-hole pattern configured to receive fasteners for mounting more than one type of actuator. The actuator may comprise a hand lever, and the mounting plate of the actuator mounting bracket may define at least one arcuate slot configured to accommodate movement of the hand lever.

Furthermore, the first and second mounting legs of the actuator mounting bracket may be configured to be removably fastened to the first and second mounting extensions, respectively. The first and second mounting legs of the actuator mounting bracket may define slots configured to receive a fastener therethrough for fastening the actuator mounting bracket to the first and second mounting extensions, respectively, such that a distance defined between the mounting plate and the damper housing is adjustable. The mounting bracket may be configured to accommodate an actuator that requires an external coupling from the actuator to the damper shaft. In some cases, the overall length of the damper in the direction of fluid flow may be between approximately three inches and approximately five inches.

In other embodiments, an actuator mounting bracket is provided that is configured to attach an actuator to a damper for opening and closing the damper. The actuator mounting bracket may comprise a first mounting leg, a second mounting leg, and a mounting plate extending between the first and second mounting legs. Each of the first and second mounting legs may be substantially perpendicular to the mounting plate, and each of the first and second mounting legs may be configured to be fastened to first and second mounting extensions defined by and integral to the damper. Furthermore, the mounting plate may define a multiple-hole pattern configured to receive fasteners for mounting more than one type of actuator.

In some cases, the first and second mounting legs may be configured to be fastened to first and second mounting extensions that are defined by a first flange and a second flange, respectively, of the damper. Moreover, the actuator may comprise a hand lever, and the mounting plate may define at least one arcuate slot configured to accommodate movement of the hand lever for opening and closing the damper. The first and second mounting legs may be configured to be removably fastened to the first and second mounting extensions, respectively. The first and second mounting legs may also define slots configured to receive a fastener therethrough for fastening the actuator mounting bracket to the first and second mounting extensions, respectively, such that a distance defined between the mounting plate and the damper is adjustable. The mounting bracket may be configured to accommodate an actuator that requires an external coupling from the actuator to a damper shaft of the damper. The first and second mounting legs and the mounting plate, in some cases, are formed from a single piece of material.

In still other embodiments, a method of attaching an actuator to a damper for opening and closing the damper is provided. A damper may be provided that comprises a damper housing defining an upstream end and a downstream end; a first flange fixed to the upstream end of the damper housing and a second flange fixed to the downstream end of the damper housing, with the first flange defining a first mounting extension and the second flange defining a second mounting extension; a damping member disposed within the housing and configured to open and close the damper; and a damper shaft connected to the damping member and extending through the damper housing, wherein the damper shaft is configured to move the damping member to open and close the damper. An actuator mounting bracket may also be provided that comprises a first mounting leg, a second mounting leg, and a mounting plate extending between the first and second mounting legs, wherein the first and second mounting legs each defines at least one slot for receiving a fastener therethrough, and wherein the mounting plate defines a multiple-hole pattern configured to be fastened to more than one type of actuator. Accordingly, the actuator mounting bracket may be positioned between the first and second mounting extensions at a predetermined distance from the damper housing, and the first and second mounting legs of the actuator mounting bracket may be fastened to the first and second mounting extensions of the damper, respectively, at the predetermined distance via the slots; and an actuator may be attached to the mounting plate via selected holes of the multiple-hole pattern based on the type of actuator to be attached. Thus, the actuator may be configured to engage and rotate the damper shaft for moving the damping member to open and close the damper.

In some cases, the method may further include the steps of detaching the actuator from the mounting plate and attaching a different type of actuator to the mounting plate via other selected holes of the multiple-hole pattern. The steps of detaching the actuator and attaching a different type of actuator may be performed while maintaining a pressure integrity of the damper.

The method may further include the steps of unfastening the first and second mounting legs of the actuator mounting bracket from the first and second mounting extensions of the damper; repositioning the actuator mounting bracket at a different predetermined distance from the damper; and fastening the first and second mounting legs of the actuator mounting bracket to the first and second mounting extensions of the damper, respectively, at the different predetermined distance via the slots. In some cases, the actuator mounting bracket may be removed, and the actuator mounting bracket may be replaced with a different actuator mounting bracket configured to accommodate a different actuator. The mounting legs and mounting plate of the actuator mounting bracket may be formed from a single piece of material, in some embodiments.

### BRIEF DESCRIPTION OF THE SEVERAL VIEWS OF THE DRAWING(S)

Reference will now be made to the accompanying drawings, which are not necessarily drawn to scale, and wherein:

FIG. 1 illustrates a containment system including isolation dampers;

FIG. 2 illustrates a flat-blade damper;

FIG. 3 illustrates a dish-style damper;

FIG. 4 illustrates a damper prior to the attachment of an actuator;

FIG. 5 illustrates a conventional mounting bracket welded to the damper housing of the damper of FIG. 4;

FIG. 6 is a schematic representation of an adjustable mounting bracket in accordance with one exemplary embodiment of the present invention;

FIG. 7 is a schematic representation of a damper with integral mounting extensions in accordance with one exemplary embodiment of the present invention;

FIG. 8 illustrates the adjustable mounting bracket of FIG. 6 and the damper of FIG. 7 in a disassembled configuration in accordance with one exemplary embodiment of the present invention;

FIG. 9 illustrates the adjustable mounting bracket of FIG. 6 and the damper of FIG. 7 in an assembled configuration in accordance with one exemplary embodiment of the present invention;

FIG. 10 is a side view of the damper of FIG. 7 with the adjustable mounting bracket attached in accordance with one exemplary embodiment of the present invention;

FIG. 11 is a plan view of the mounting plate of the adjustable mounting bracket of FIG. 6 showing a multiple-hole pattern and arcuate slots in accordance with one exemplary embodiment of the present invention;

FIG. 12 illustrates the multiple-hole pattern of the mounting plate of FIG. 11 in accordance with one exemplary embodiment;

FIG. 13A shows the adjustable mounting bracket fastened to the mounting extensions of the damper in a lowered position in accordance with one exemplary embodiment of the present invention; and

FIG. 13B shows the adjustable mounting bracket fastened to the mounting extensions of the damper in a raised position in accordance with one exemplary embodiment of the present invention.

### DETAILED DESCRIPTION

Embodiments of the present invention now will be described more fully hereinafter with reference to the accompanying drawings, in which some, but not all embodiments are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

A compact damper and an adjustable mounting bracket are provided for controlling fluid flow through a duct between an upstream portion of the duct and a downstream portion of the duct. The adjustable mounting bracket includes two mounting legs and a mounting plate extending between the mounting legs. The mounting legs are configured to be fixed to corresponding mounting extensions that extend from and are integral to the damper. The adjustable mounting bracket defines various slots and holes to provide adjustability in both the position of the adjustable mounting bracket with respect to the damper and the type of actuator that can be accommodated by the mounting bracket. In this way, an actuator may be installed/replaced while maintaining the pressure integrity of the damper. In addition, the integral mounting extensions facilitate proper alignment of the actuator with the damper and provide additional support for larger actuators. Methods for attaching an actuator to a damper are also provided.

In describing the structure and function of the damper and adjustable mounting bracket according to various embodiments, the example of a containment system is used. It is understood, however, that the damper and/or adjustable mounting bracket may be used in any type of system for stopping or otherwise controlling the flow of any fluid through the system. In addition, although reference is made to “ducts” and “ductwork,” it is understood that embodiments of the damper and actuator mounting system may be installed on any type of fluid conduit, including ducts, chimneys, Variable Air Volume (VAV) boxes, and air handlers, and these terms may be used interchangeably. Furthermore, embodiments of the damper and adjustable mounting bracket may be used to control the flow of a variety of fluids, including gaseous fluids (such as air) as well as liquid fluids (such as water). For ease of explanation, and in the context of containment systems, the damper and adjustable mounting bracket will be described as controlling the flow of air.

Containment systems generally include multiple sections of ductwork connected in series via gasketed and bolted or welded connections. Such systems may be installed on the supply side or the exhaust side of ventilation systems, depending on the specific application.

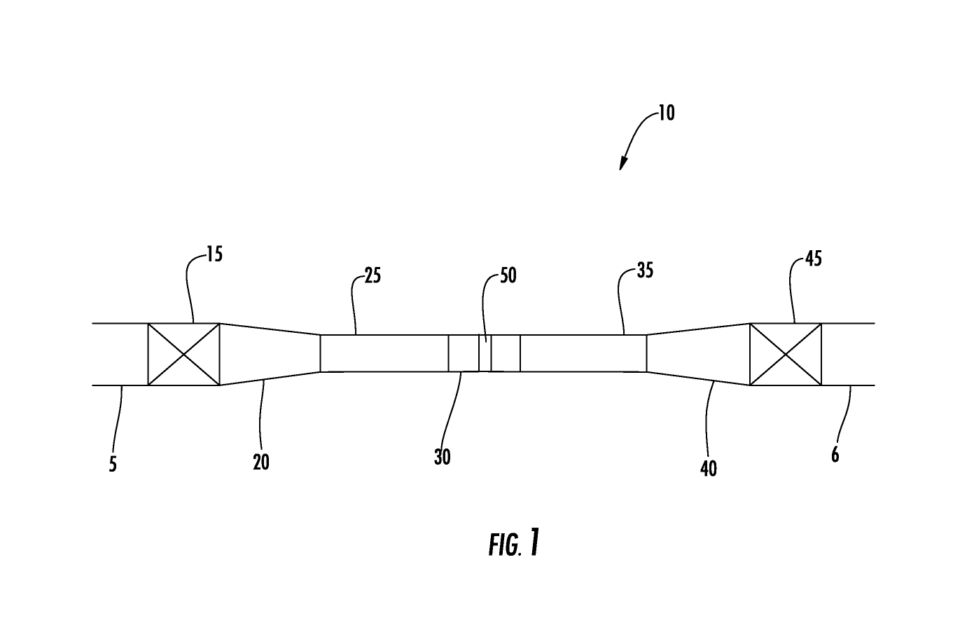

Each section of the containment systems generally serves a specific function. FIG. 1 illustrates one example of a containment system 10 that includes an upstream isolation damper 15, an upstream transition 20, an upstream test section 25, a HEPA filter section 30, a downstream test section 35, a downstream transition 40, and a downstream isolation damper 45. The upstream isolation damper 15 may be used to isolate the containment system 10 from the upstream ductwork 5, and the upstream transition 20 may be used to transition from the upstream isolation damper to the upstream test section 25. The upstream test section 25 may be used, for example, to introduce a challenge aerosol to the airstream flowing through the system to evaluate a HEPA filter 50 held and sealed in the HEPA filter section 30. The downstream test section 35 may be used in conjunction with the upstream test section 25 to sample the air downstream of the HEPA filter 50 to determine, for example, if there are leaks in the HEPA filter. The downstream transition 40 may be used to transition from the downstream test section 35 to the downstream isolation damper 45, and the downstream isolation damper may be used to isolate the containment system 10 from the downstream ductwork 6. Thus, in the example of FIG. 1, two isolation dampers 15, 45 are used to isolate the sections of the ductwork being tested from the rest of the system.

The number and type of sections required for each containment system is dependent upon multiple factors, including but not limited to the nature of the contaminants present; the type of facility; federal, state and local regulations; and applicable industry standards for the design and operation of a given facility. For example, a particular facility may not require an upstream test section, but may instead introduce the challenge aerosol via the inlet of a blower system (not shown) that supplies air to the containment system.

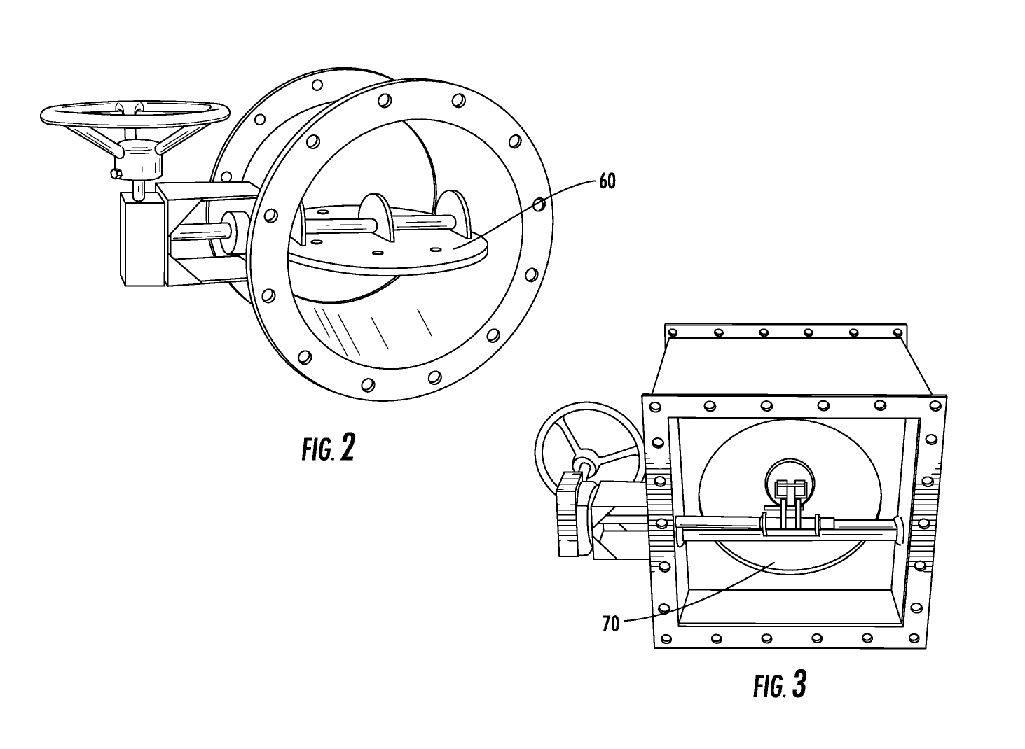

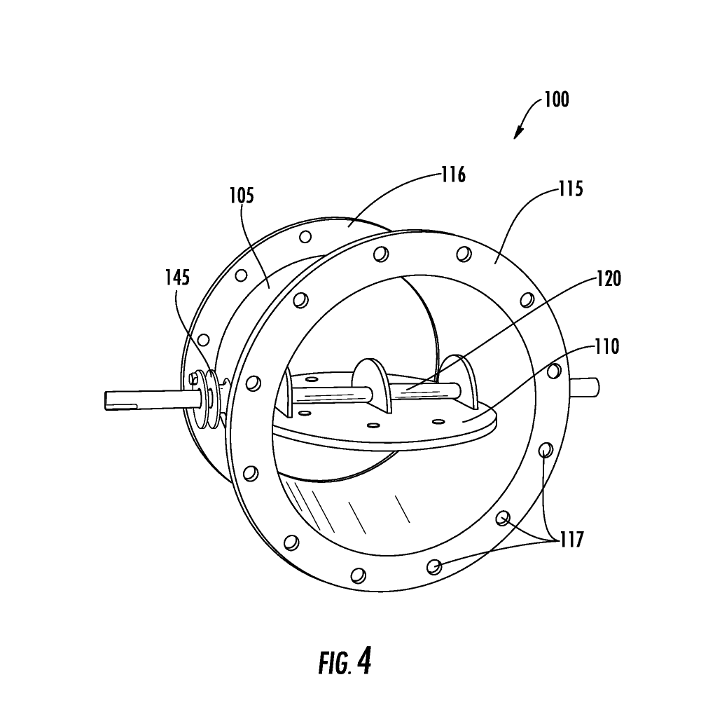

There are several types of dampers that may be used for applications such as the containment system 10 described above, which may fall into the following categories: (1) round flat-blade dampers; (2) square or rectangular flat-blade dampers; and (3) dish-style dampers. Round dampers are designed for sealing off and/or controlling airflow in round ducts and pipes, whereas square or rectangular dampers are used in square or rectangular ductwork, respectively. In flat-blade dampers, the damping member 60 (i.e., the component that is movable to seal or partially block the flow of air through the damper) is a flat plate, as shown in FIG. 2. The damper in a flat blade damper may be closed or opened to varying degrees. Thus, in some applications, flat blades may be used to throttle flow. In dish-style dampers, however, the damping member 70 has a “dish” shape (e.g., is at least partially concave with respect to the direction of air flow), as shown in FIG. 3. In contrast to flat blade dampers, dish-style dampers generally have only two positions (i.e., open or closed). A damper may be used as a single damper in ductwork, or in some cases may be grouped in various configurations to form a bank of dampers for a system.

Regardless of the particular style of damper, dampers typically use an actuator to open and close the damping member (e.g., the blade or the dish) and to effectively create a seal that is capable of meeting the leak-test requirements of industry standards such as ASME N510 or ASME N511. There are various types of actuators, which may be manually, pneumatically, electrically, or mechanically operated, and actuators are generally available in a wide variety of sizes, shapes, and torque outputs and have a variety of features and functions.

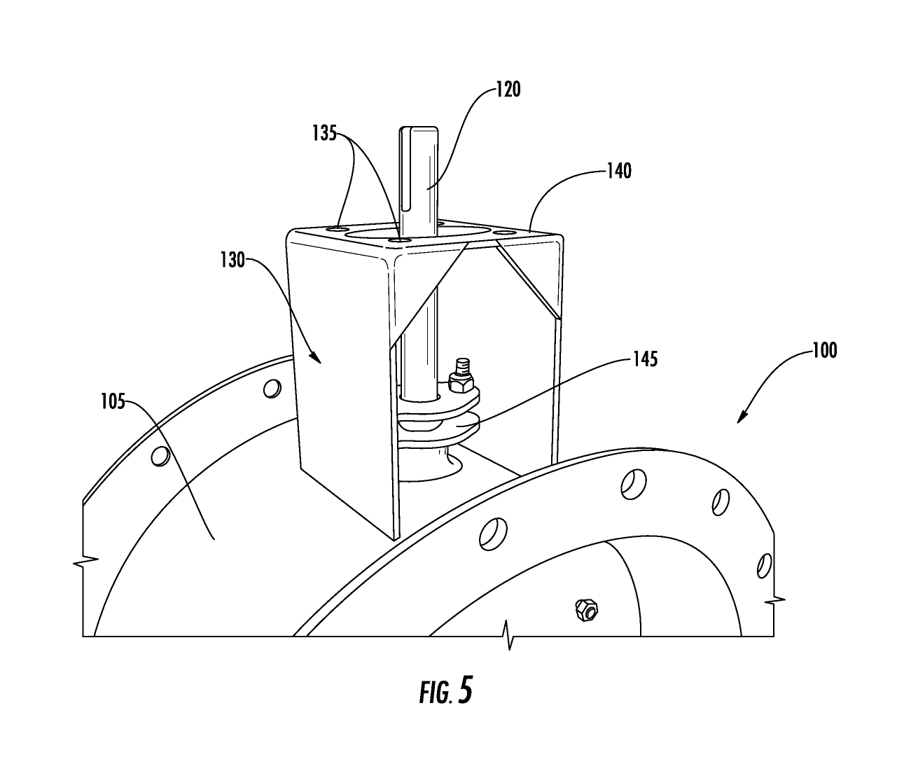

With reference to FIG. 4, in general, a damper 100 may include a damper housing 105, a damping member 110, first and second flanges 115, 116 that are configured to be attached to upstream and downstream portions of the ductwork, respectively, and a damper shaft 120 connected to the damping member and extending through the damper housing. The damper shaft 120 may be configured to be movable between a closed position, in which the damper member 110 is substantially perpendicular to the direction of fluid flow through the housing 105, and an open position (as illustrated), in which the damping member is substantially parallel to the direction of fluid flow through the housing.

The damper housing 105 typically forms the main body of the damper 100, and the outer edge of the damping member 110 may be configured to form a seal with the inner surface of the damping member such that fluid is substantially precluded from passing through the damper when the damping member is in the closed position. In this regard, a gasket or seal ring may be secured to the outer edge of the damping member 110. Alternatively, the gasket may be installed between two portions that combine to form the damping member 110 such that, when the two portions are engaged with each other, the gasket protrudes radially to form the seal with the inner diameter of the damper housing 105. As another option, the gasket may be installed on the inner diameter of the damping housing 105. In FIG. 4, the damper 100 is depicted as a flat blade damper; however, the damping member 110 may be any type of damping member, including a dish-style damping member.

The first and second flanges 115, 116, which may be plate flanges, may be mounted (e.g., continuously welded) to upstream and downstream ends of the damper housing 105. The flanges 115, 116 may be configured, as noted above, to be removably fastened (e.g., bolted) to corresponding flanges on upstream and downstream portions of the surrounding ductwork. In this regard, the first and second flanges 115, 116 may include holes 117 configured to receive fasteners (such as bolts).

As noted above, the damper shaft 120 may be secured to the damping member 110, such as by welding, and may extend through the damper housing 105 for engagement with the actuator (not shown). The actuator, which may be manually, pneumatically, electrically or mechanically operated, may thus be attached to the shaft 120 so as to rotate the shaft and open or close the damper. The location(s) where the shaft penetrates the damper housing 105 may be gasketed or sealed in order to prevent leakage.

The damper shaft 120 typically interfaces with the actuator via a coupling, keyed shaft, or some other method suitable to ensure that the damping member 110 will rotate and seal effectively over an extended operating life (e.g., more than 25,000 open/close cycles) of the damper 100. Generally, each actuator manufacturer uses a unique style of shaft interface. For example, some actuators are designed with a “square socket” in which a removable square plug is installed. Thus, in this case, the end of the damper shaft 120 itself must be square and the same size as the square socket, or a square plug must be machined and secured to the damper shaft via welding or a keyway to allow the shaft to interface with the actuator. Other actuators may use sockets that include splines, hexes, or a variety of other shapes in conjunction with a correspondingly shaped plug to provide an interface between the actuator and the damper shaft 120.

Another feature that may vary between different actuators is the depth of the socket, when measured from the face of the installed actuator nearest the damper housing. For example, typical socket depths may range from ½ inch to 1½ inches in depth, depending on the manufacturer.

In addition, the amount of torque required to open and close an isolation damper typically varies based on the type of damping member (e.g., flat blade vs. dish-style), the size of the damping member (e.g., smaller diameter damping members require less torque than larger diameter damping members), the type of gasket or seal used between the damper housing and damping member, and the type of seal used where the damper shaft penetrates the damper housing, among other variables. Actuators with more torque are generally larger than actuators with less torque and, thus, typically require a heavier-duty, more robust support.

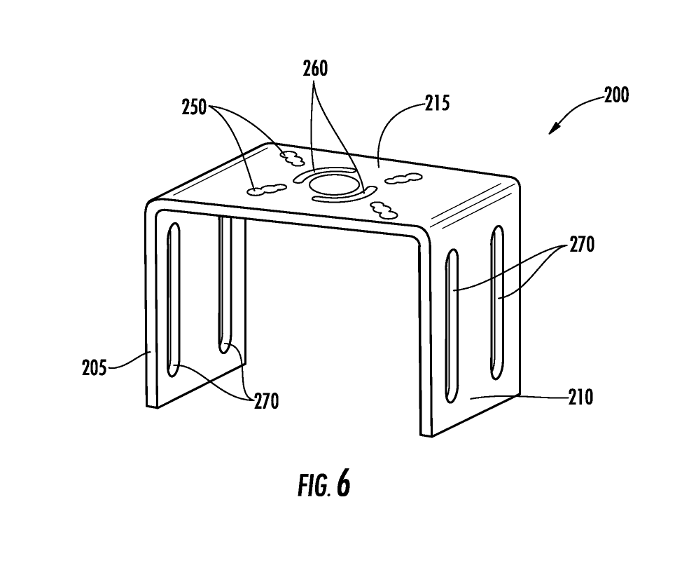

One way to attach an actuator to a damper is to bolt the actuator to a mounting bracket 130 that is welded to an outer surface of the damper housing 105, as illustrated in FIG. 5. Due to the variations in the actuator type, the actuator size, and the depth of the socket interface among different actuators, mounting brackets have generally been designed to accommodate only certain types of actuators (e.g., an actuator with a certain socket depth, shaft length, mounting bolt pattern, etc.). Thus, during manufacturing, the length of the damper shaft 120 may need to be modified to accommodate the actuator being installed. Similarly, when an actuator must be replaced (such as when a previously installed actuator fails in operation in the field), the mounting bracket 130 and/or damper shaft 120 may need to be modified or replaced, especially if a different actuator is used.

If the mounting bracket 130 is welded to the damper housing 105, which is a pressure boundary of the damper, any cutting of welds or rewelding on the damper housing can potentially create a leak path. Thus, the damper may need to be leak-tested after any cutting of welds or rewelding in order to ensure the integrity of the pressure boundary, which is both costly and time consuming.

In addition, the installation of mounting brackets such as the mounting bracket 130 pictured in FIG. 5 must be done carefully to ensure proper and efficient functioning of the actuator and the damper. For example, the mounting bracket must be aligned such that the bolt-hole pattern 135 for the actuator is concentric to the damper shaft 120. If it is not concentric, then the damper shaft 120 may not properly align with the socket in the actuator once the actuator is installed. Also, if the concentricity is too far off, it may not be possible to engage the damper shaft 120 in the actuator socket, making it difficult, if not impossible, to mount the actuator onto the bracket 130.

Furthermore, it is important that the actuator bracket 130 be designed and fabricated such that the surface 140 onto which the actuator mounts is substantially perpendicular to the damper shaft 120. If the mounting surface 140 is not perpendicular to the damper shaft 120, the actuator will not sit properly on the mounting surface when the shaft is engaged in the actuator socket. Proper mounting is important to avoid creating a “bind” between the damper shaft and the actuator socket, which increases the torque required to open and close the damping member.

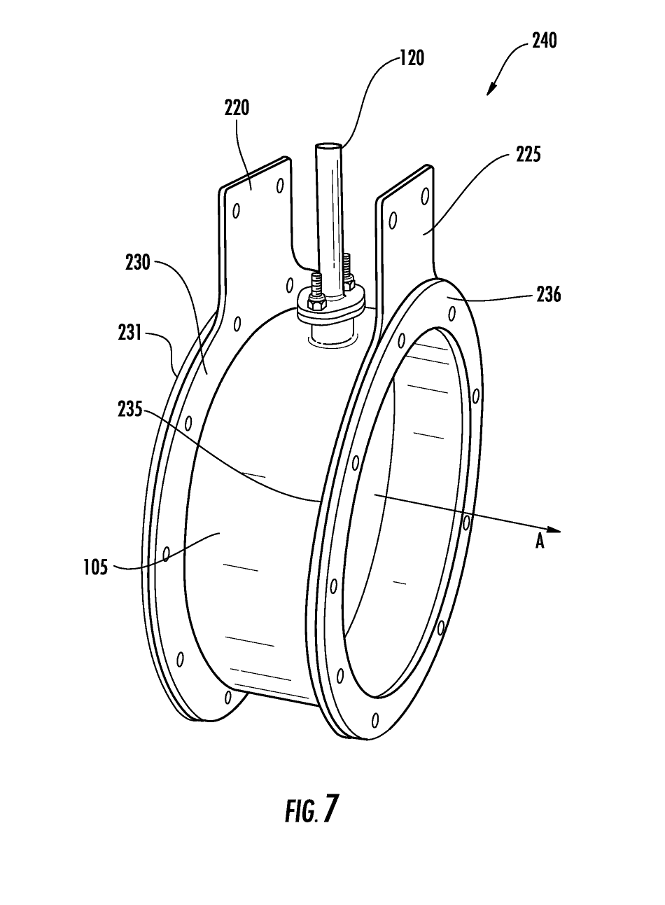

Embodiments of the present invention provide an adjustable mounting bracket and methods for mounting an actuator to a damper such that many different types of actuators may be installed using the same mounting bracket (i.e., without having to modify or replace the mounting bracket or the damper shaft). Turning to FIG. 6, the adjustable mounting bracket 200 comprises a first mounting leg 205, a second mounting leg 210, and a mounting plate 215 extending between the first and second mounting legs. Each of the first and second mounting legs 205, 210 may be substantially perpendicular to the mounting plate 215, and the first and second mounting legs 205, 210 and the mounting plate 215 may be formed from a single piece of material. For example, the first and second mounting legs 205, 210 and the mounting plate 215 of the adjustable mounting bracket 200 may be made from a single piece of stainless steel, carbon steel, Hastelloy® metal alloy, or other materials. The thickness or gauge of the material may be selected based on the strength requirements for the particular application.

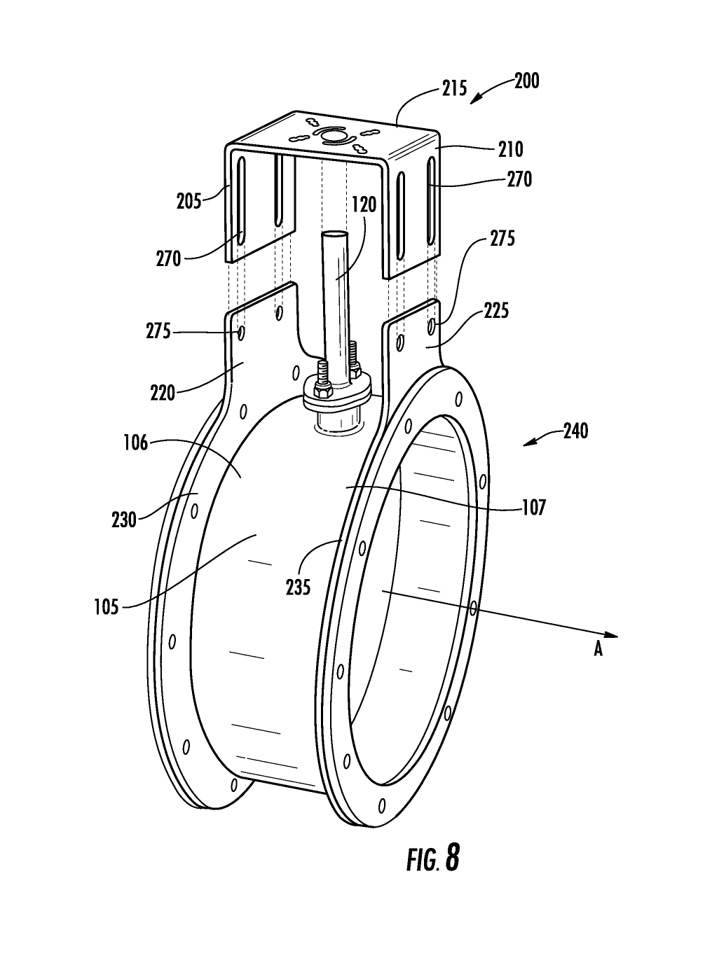

The first and second mounting legs 205, 210 may be configured to be fastened to corresponding first and second mounting extensions 220, 225, shown in FIGS. 7 and 8, that are defined by the first and second flanges 230, 235 of the damper 240. The first flange 230 may be fixed (e.g., continuously welded) to an upstream end 106 of the damper housing 105 and a second flange 235 may be fixed to the downstream end 107 of the damper housing (shown in FIG. 8), such that each flange may be attached to the respective upstream and downstream portions of the surrounding ductwork. In this regard, a sealing material or gasket 231, 236 may be attached (e.g., adhered) to each flange 230, 235 to facilitate sealing engagement with the adjacent ducts.

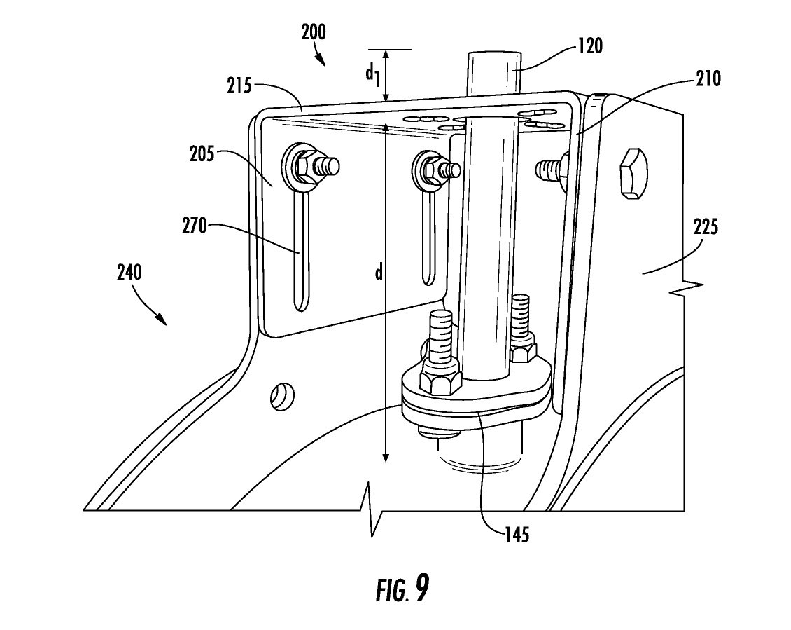

Referring to FIG. 7, the first and second mounting extensions 220, 225 may be integral to the first and second flanges 230, 235. Thus, the first and second mounting extensions 220, 225 may be made of the same material as the flanges 230, 235, which in many cases is a heavier gage material than would have been used in the mounting bracket 130 depicted in FIG. 5, for example. As a result, when the adjustable mounting bracket 200 is fastened to the first and second flanges 230, 235, as shown in FIG. 9, the rigidity of the mounting bracket is enhanced, and the adjustable mounting bracket is thereby able to accommodate various sizes of actuators, including larger actuators requiring greater support.

Furthermore, the ability to secure the adjustable mounting bracket 200 to the damper 240 by fastening the bracket to the first and second flanges 230, 235 eliminates the need to weld the mounting bracket to the damper, which avoids the time and cost associated with both the welding operation and any leak testing of the damper that would have been conducted otherwise. In addition, the fact that the first and second mounting extensions 220, 225 are integral to the first and second flanges 230, 235 and are manufactured at the same time as the damper 240 ensures that the mounting extensions will extend substantially perpendicularly to the direction of air flow A and will be positioned properly with respect to the damper shaft 120, thereby facilitating proper alignment and positioning of the adjustable mounting bracket 200 and, as a result, the actuator. In other words, the integral nature of the first and second mounting extensions 220, 225 results in the adjustable mounting bracket 200 being automatically aligned with the damper 240.

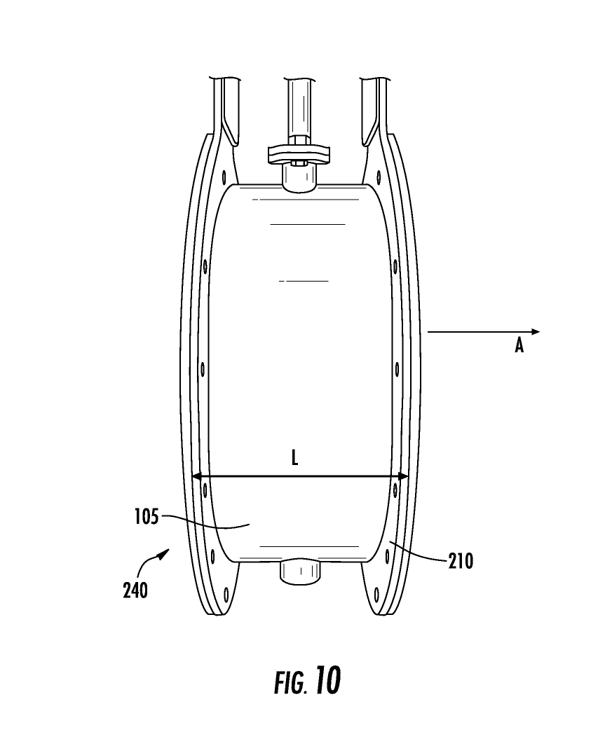

In addition, having first and second mounting extensions 220, 225 that are integral to the first and second flanges 230, 235 allows for a reduction of the overall length L of the damper 240 (i.e., measured in the direction of fluid flow A, as illustrated in FIG. 10). This is because in configurations in which a separate mounting bracket 130 is used, as depicted in FIG. 5, for example, clearance must be provided between the flanges of the damper and the legs of the mounting bracket to allow for access to the seal 145. In contrast, first and second mounting extensions 220, 225 that are integral to the first and second flanges 230, 235 allow for the installation of the adjustable mounting bracket 200 in the configuration shown in FIG. 9, in which access to the seal 145 is not impaired by the reduction of the length L of the damper when the adjustable mounting bracket 200 is installed. In other words, the orientation of the adjustable mounting bracket 200 with respect to the damper 240 (i.e., with mounting legs 205, 210 disposed at the ends of the damper 204, as shown in FIG. 9, rather than extending between the ends of the damper 100, as is the case with the mounting bracket 130 shown in FIG. 5) may allow for easier access to and maintenance of the seal 145 between the damper housing 105 and the damper shaft 120 as compared to conventional actuator brackets. Thus, for example, by using a damper 240 with first and second mounting extensions 220, 225 that are integral to the first and second flanges 230, 235, the overall length L of the damper 240 may be reduced from approximately 9 inches in dampers 100 without first and second mounting extensions to between approximately 3 inches and approximately 5 inches, thereby increasing the available floor space in mechanical rooms and ductwork where such compact dampers are used. Moreover, any reduction in overall length L translates to a reduction in the cost of the damper, as less material is used to make the damper housing 105, as well as a reduction in the cost of installation, as the configuration allows for easier alignment of the adjustable mounting bracket 200 with the damper 240, facilitating installation.

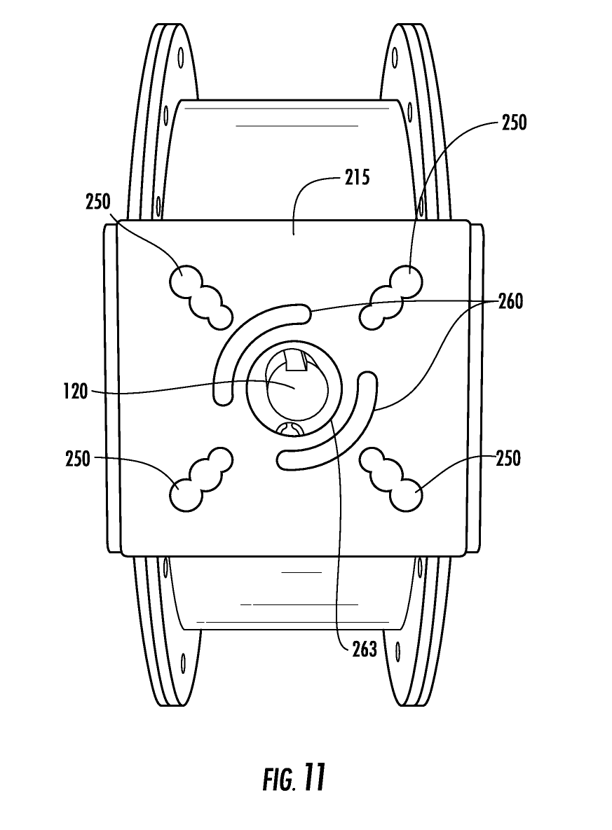

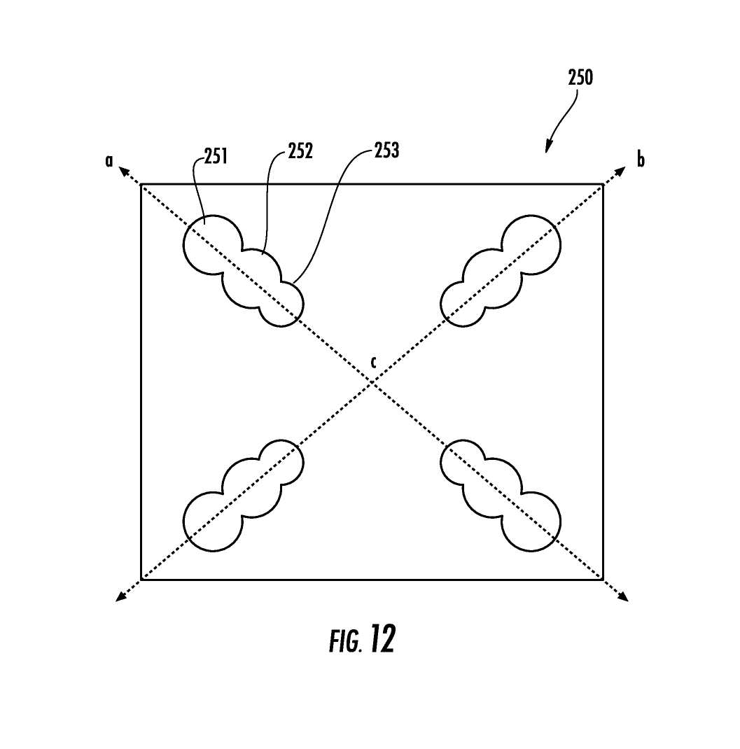

With reference to FIG. 11, in some embodiments, the mounting plate defines a multiple-hole pattern 250 configured to receive fasteners for mounting more than one type of actuator. For example, a multiple-hole pattern 250 may be cut out of the mounting plate 215 based on ISO standards and may correspond to the mounting bolt pattern of a wide variety of actuators. The multiple-hole pattern 250 may include two or more overlapping holes, and the holes may overlap to various degrees. In the depicted embodiment of FIG. 11 (shown close-up in FIG. 12), the multiple-hole pattern 250 includes four (4) groups of three (3) overlapping, non-concentric holes. The overlapping holes of each group are arranged along axes a, b that cross each other proximate a center point c of the mounting plate 215, as illustrated in FIG. 12. The holes may be equally sized, or, as depicted, one or more of the holes may be bigger than the others. Various other arrangements and configurations of the overlapping holes are possible, however, depending on the actuators to be accommodated.

In FIGS. 11 and 12, for example, each group of holes includes an outermost hole 251, an intermediate hole 252, and an innermost hole 253. The innermost holes 253 are sized to have a slightly smaller diameter than the outermost and intermediate holes 251, 252. Thus, for example, one type of actuator, which may have a larger footprint, may have a mounting bolt pattern (and may be configured to be fastened using a certain bolt size) that corresponds to the size and position of the outermost holes 251, whereas a smaller actuator with a smaller footprint may have a mounting bolt pattern and bolt size that corresponds to the innermost holes 253. Still another type of actuator may have a mounting bolt pattern and bolt size that corresponds to the intermediate holes 252. In this way, various actuators can be secured to the damper 240 without having to modify or replace the adjustable mounting bracket 200. In addition, the definition of at least part of the circumference of each hole in a given group of overlapping holes (as opposed to having a slot) allows for easier installation of the bolts (e.g., allows the bolts to be self-aligning) and provides for the actuator, once fastened, to remain in position with respect to the adjustable mounting bracket 200.

Turning again to FIG. 11, the mounting plate 215 of the adjustable mounting bracket 200 may also define at least one arcuate slot 260 configured for accommodating the movement of a hand lever for opening and closing the damper 240 (e.g., when the damper is configured to be manually actuated, and the actuator includes a hand lever). For example, the mounting plate 215 may define two diametrically opposed arcuate slots 260, as illustrated in FIG. 11. In addition, an opening 263 may be provided in the center of the mounting plate 215 that is sized to allow the damper shaft 120 or coupling to pass through the adjustable mounting bracket so that it may be engaged by the actuator, as described above. For example, the opening 263 may be sized to receive the largest-diameter damper shaft or coupling contemplated, while also accommodating any smaller diameter damper shafts, as necessary.

As noted above, the first and second mounting legs 210, 215 of the adjustable mounting bracket 200 may be configured to be removably fastened to the first and second mounting extensions 220, 225, respectively, such as through the use of bolts or other fasteners. Thus, for example, when bolts are used to fasten the first and second mounting legs 210, 215, the adjustable mounting bracket 200 may be removed and replaced with another mounting bracket (e.g., one with a different multiple-hole pattern) in the field without requiring any cutting or rewelding of the bracket or the damper.

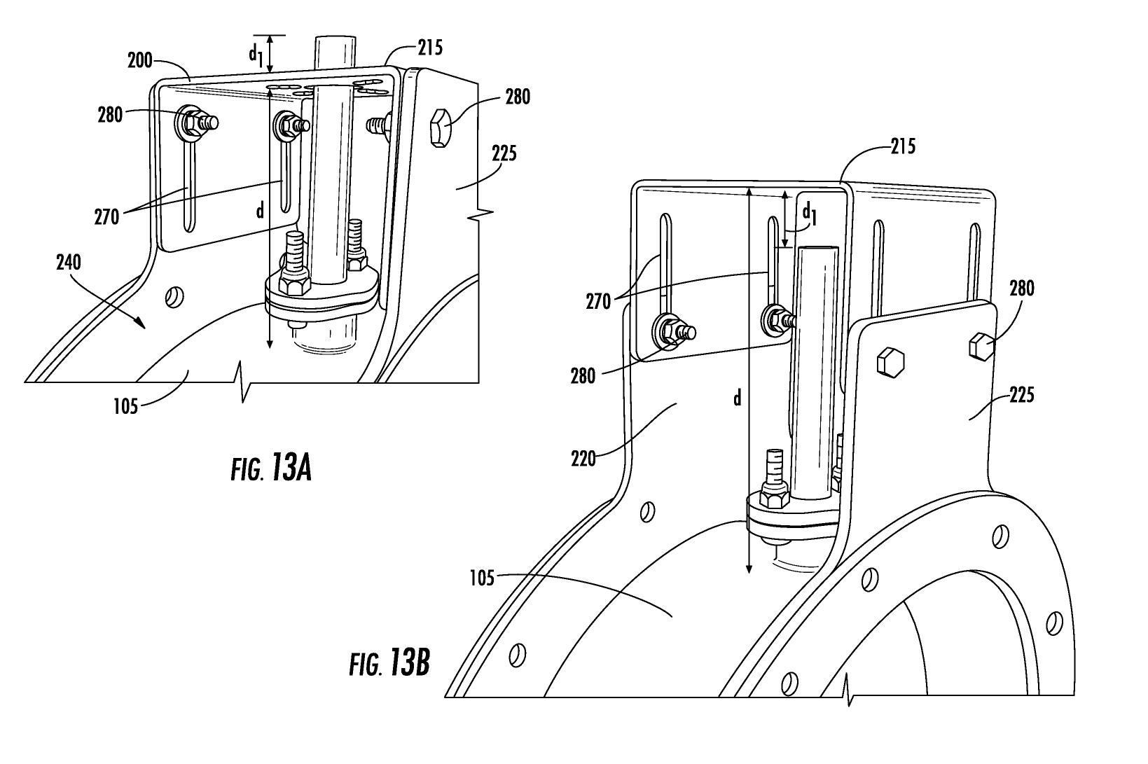

Referring to FIGS. 6, 13A, and 13B, in some embodiments, the first and second mounting legs 205, 210 of the adjustable mounting bracket 200 may define slots 270 configured to receive a fastener therethrough for fastening the adjustable mounting bracket to the first and second mounting extensions 220, 225, respectively, such that a distance d defined between the mounting plate 215 and the damper housing 105 and the distance dl between the mounting plate 215 and the top end of the damper shaft 120 are adjustable, as illustrated in FIGS. 13A and 13B. For example, two slots 270 may be defined in each of the first and second mounting legs 205, 210, and each slot may extend from a location proximate the mounting plate 215 towards an end of the respective mounting leg proximate the damper housing 105. The slots 270 may be parallel to each other, as shown, and may be aligned with holes 275 defined by the first and second mounting extensions 220, 225 (shown in FIG. 8).

Thus, the position of the adjustable mounting bracket 200 with respect to the damper 240 may be adjustable such that an actuator requiring an external coupling (e.g., requiring a larger distance d) may be accommodated. For example, the adjustable mounting bracket 200 in one instance may be positioned such that a fastener 280 received by the hole 275 would engage the corresponding slot 270 at an uppermost portion of the slot (e.g., closest to the mounting plate 215, in a lowered position), as shown in FIG. 13A, thereby allowing the damper shaft 120 to engage directly to the actuator or to a short coupling, depending on the particular design of the actuator. In another case, however, where an actuator is used that requires an external coupling from the actuator to the damper shaft 120, for example, the actuator mounting plate 200 may be positioned such that a fastener 280 received by the hole 275 would engage the corresponding slot 270 at a lowermost portion of the slot (e.g., farthest from the mounting plate 215, in a raised position), as shown in FIG. 13B. The adjustable mounting bracket 200 may be moved from one position to the next by loosening the fasteners holding each mounting leg 205, 210 and sliding the mounting bracket along the slots 270 to the new position (i.e., without completely removing the fasteners). In some embodiments, the slots 270 are configured to move the mounting plate 215 away from the damper 240 by approximately 2 inches.

Use of a damper 240 and an adjustable mounting bracket 200 as described above provides a simplified and cost effective way to accommodate various types of actuators using the same accessories and allows for easier installation and replacement of actuators in the field, for example, by eliminating the need for welding the damper housing. Embodiments of the invention described above also allow standardization to one bracket that can be installed on existing dampers.

Accordingly, a method of attaching an actuator to a damper for opening and closing the damper is provided. As noted above, a damper and an adjustable mounting bracket are initially provided. The damper includes a damper housing defining an upstream end and a downstream end and first and second flanges fixed to the upstream and downstream ends of the damper housing, respectively. The first flange defines a first mounting extension and the second flange defines a second mounting extension. The damper also includes a damping member disposed within the housing and configured to open and close the damper, as well as a damper shaft connected to the damping member and extending through the damper housing, such that the damper shaft is configured to move the damping member to open and close the damper.

The adjustable mounting bracket comprises a first mounting leg, a second mounting leg, and a mounting plate extending between the first and second mounting legs. The first and second mounting legs each defines at least one slot for receiving a fastener therethrough, and the mounting plate defines a multiple-hole pattern configured to be fastened to more than one type of actuator.

As described above, the adjustable mounting bracket may be positioned between the first and second mounting extensions at a predetermined distance from the damper housing. The first and second mounting legs of the adjustable mounting bracket may then be fastened to the first and second mounting extensions of the damper, respectively, at the predetermined distance via the slots. An actuator configured to engage and rotate the damper shaft for moving the damping member to open and close the damper may be attached to the mounting plate via selected holes of the multiple-hole pattern based on the type of actuator to be attached.

In some cases, the actuator may be detached from the mounting plate, and a different type of actuator may be attached to the mounting plate via other selected holes of the multiple-hole pattern. In this way, the same adjustable mounting bracket may be used for different actuators, such as when an actuator needs replacement in the field. Thus, detaching the actuator and attaching a different type of actuator may be performed while maintaining the pressure integrity of the damper.

In some embodiments, the first and second mounting legs of the adjustable mounting bracket may be unfastened from the first and second mounting extensions of the damper, and the adjustable mounting bracket may be repositioned at a different predetermined distance from the damper. The first and second mounting legs of the adjustable mounting bracket may then be fastened to the first and second mounting extensions of the damper, respectively, at the different predetermined distance via the slots.

Furthermore, the adjustable mounting bracket may be removed and replaced with a different adjustable mounting bracket configured to accommodate a different actuator. For example, a previously installed adjustable mounting bracket having a particular multiple-hole pattern may be replaced with another adjustable mounting bracket having a different multiple-hole pattern, for example to accommodate an actuator with a mounting bolt pattern that does not correspond to the multiple-hole pattern of the previously installed mounting bracket.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A damper for controlling fluid flow through a duct between an upstream portion of the duct and a downstream portion of the duct, the damper comprising:
a damper housing defining an upstream end and a downstream end;
a first flange fixed to the upstream end of the damper housing and a second flange fixed to the downstream end of the damper housing, wherein each flange is configured to be attached to the respective upstream and downstream portions of the duct;
a damping member disposed within the housing and configured to be movable between a closed position, in which the damping member is substantially perpendicular to the direction of fluid flow through the housing, and an open position, in which the damping member is substantially parallel to the direction of fluid flow through the housing;
a damper shaft connected to the damping member and extending through the damper housing, wherein the damper shaft is configured to move the damping member between the open and closed positions; and
an actuator mounting bracket configured to attach an actuator to the damper housing, wherein the actuator is configured to engage and rotate the damper shaft for moving the damping member between the open and closed positions,
wherein the first flange defines a first mounting extension and the second flange defines a second mounting extension,
wherein the actuator mounting bracket defines first and second mounting legs and a mounting plate extending between the first and second mounting legs, and
wherein the first and second mounting legs are configured to be fastened to the first and second mounting extensions, respectively, and the mounting plate is configured to be fastened to the actuator.

2. The damper of claim 1, wherein the mounting plate of the actuator mounting bracket defines a multiple-hole pattern configured to receive fasteners for mounting more than one type of actuator.

3. The damper of claim 1, wherein the actuator comprises a hand lever, and wherein the mounting plate of the actuator mounting bracket defines at least one arcuate slot configured to accommodate movement of the hand lever.

4. The damper of claim 1, wherein the first and second mounting legs of the actuator mounting bracket are configured to be removably fastened to the first and second mounting extensions, respectively.

5. The damper of claim 1, wherein the first and second mounting legs of the actuator mounting bracket define slots configured to receive a fastener therethrough for fastening the actuator mounting bracket to the first and second mounting extensions, respectively, such that a distance defined between the mounting plate and the damper housing is adjustable.

6. The damper of claim 5, wherein the mounting bracket is configured to accommodate an actuator that requires an external coupling from the actuator to the damper shaft.

7. The damper of claim 1, wherein an overall length of the damper in the direction of fluid flow is between approximately three inches and approximately five inches.

8. An actuator mounting bracket configured to attach an actuator to a damper for opening and closing the damper, the actuator mounting bracket comprising a first mounting leg, a second mounting leg, and a mounting plate extending between the first and second mounting legs,
wherein each of the first and second mounting legs are substantially perpendicular to the mounting plate,
wherein each of the first and second mounting legs are configured to be fastened to first and second mounting extensions defined by and integral to the damper, and
wherein the mounting plate defines a multiple-hole pattern configured to receive fasteners for mounting more than one type of actuator.

9. The actuator mounting bracket of claim 8, wherein the first and second mounting legs are configured to be fastened to first and second mounting extensions that are defined by a first flange and a second flange, respectively, of the damper.

10. The actuator mounting bracket of claim 8, wherein the actuator comprises a hand lever, and wherein the mounting plate defines at least one arcuate slot configured to accommodate movement of the hand lever for opening and closing the damper.

11. The actuator mounting bracket of claim 8, wherein the first and second mounting legs are configured to be removably fastened to the first and second mounting extensions, respectively.

12. The actuator mounting bracket of claim 8, wherein the first and second mounting legs define slots configured to receive a fastener therethrough for fastening the actuator mounting bracket to the first and second mounting extensions, respectively, such that a distance defined between the mounting plate and the damper is adjustable.

13. The actuator mounting bracket of claim 12, wherein the mounting bracket is configured to accommodate an actuator that requires an external coupling from the actuator to a damper shaft of the damper.

14. The actuator mounting bracket of claim 8, wherein the first and second mounting legs and the mounting plate are formed from a single piece of material.

15. A method of attaching an actuator to a damper for opening and closing the damper, the method comprising the steps of:
providing a damper comprising:
a damper housing defining an upstream end and a downstream end;
a first flange fixed to the upstream end of the damper housing and a second flange fixed to the downstream end of the damper housing, the first flange defining a first mounting extension and the second flange defining a second mounting extension;
a damping member disposed within the housing and configured to open and close the damper; and
a damper shaft connected to the damping member and extending through the damper housing, wherein the damper shaft is configured to move the damping member to open and close the damper;
providing an actuator mounting bracket comprising a first mounting leg, a second mounting leg, and a mounting plate extending between the first and second mounting legs, wherein the first and second mounting legs each defines at least one slot for receiving a fastener therethrough, and wherein the mounting plate defines a multiple-hole pattern configured to be fastened to more than one type of actuator;
positioning the actuator mounting bracket between the first and second mounting extensions at a predetermined distance from the damper housing;
fastening the first and second mounting legs of the actuator mounting bracket to the first and second mounting extensions of the damper, respectively, at the predetermined distance via the slots; and
attaching an actuator to the mounting plate via selected holes of the multiple-hole pattern based on the type of actuator to be attached, wherein the actuator is configured to engage and rotate the damper shaft for moving the damping member to open and close the damper.

16. The method of claim 15 further comprising the steps of:
detaching the actuator from the mounting plate; and
attaching a different type of actuator to the mounting plate via other selected holes of the multiple-hole pattern.

17. The method of claim 16, wherein the steps of detaching the actuator and attaching a different type of actuator are performed while maintaining a pressure integrity of the damper.

18. The method of claim 16 further comprising the steps of:
unfastening the first and second mounting legs of the actuator mounting bracket from the first and second mounting extensions of the damper;
repositioning the actuator mounting bracket at a different predetermined distance from the damper; and
fastening the first and second mounting legs of the actuator mounting bracket to the first and second mounting extensions of the damper, respectively, at the different predetermined distance via the slots.

19. The method of claim 15 further comprising the step of removing the actuator mounting bracket and replacing the actuator mounting bracket with a different actuator mounting bracket configured to accommodate a different actuator.

20. The method of claim 15, wherein the mounting legs and mounting plate of the actuator mounting bracket are formed from a single piece of material.
